(19) United States
(12) Patent Application Publication
(10) Pub. No.: US 2020/0238206 A1
(43) Pub. Date: Jul. 30, 2020

(54) METHOD OF MANUFACTURING A CARBON-BASED STRUCTURE USING LASER RADIATION AND CORRESPONDING DEVICE

(71) Applicant: M-SOLV LIMITED, Oxford, Oxfordshire (GB)

(72) Inventors: Sebastian NUFER, Oxford (GB); Adam North BRUNTON, Eynsham (GB)

(73) Assignee: M-SOLV LIMITED, Oxford, Oxfordshire (GB)

(21) Appl. No.: 16/648,047

(22) PCT Filed: Sep. 14, 2018
(86) PCT No.: PCT/GB2018/052635

§ 371 Date: Mar. 17, 2020

(30) Foreign Application Priority Data
Sep. 18, 2017 (GB) 1714988.1
Jan. 12, 2018 (GB) 1800545.4
Apr. 4, 2018 (GB) 1805550.9

(51) Int. Cl. B01D 39/20; G01N 27/12

(52) U.S. Cl. CPC B01D 39/2055; B01D 39/2027; B01D 2239/10; G01N 27/126; B01D 2239/0478; G01N 27/127

(57) ABSTRACT

Methods of manufacturing a sensor or a filter are disclosed. In one arrangement, a donor material is provided on a support substrate. The donor material comprises carbon or a carbon compound. A collecting substrate is provided. The donor material is illuminated with laser radiation. The illumination is such that a porous material comprising carbon is formed on the collecting substrate. The collecting substrate comprises an electrode arrangement configured to provide an output dependent on an electrical property of a portion of the porous material.

The invention relates to manufacturing a sensor that uses a porous material comprising carbon, and to manufacturing a filter that uses a porous material comprising carbon.

Gas sensors based on chemiresistors are known. Chemiresistors are materials whose electrical resistivity changes in response to the presence of a target substance. The target substance interacts chemically with the chemiresistor material, for example by covalent bonding, hydrogen bonding, or molecular recognition. Materials known to have chemiresistor properties include metal oxide semiconductors, conductive polymers, and nanomaterials such as graphene, carbon nanotubes and nanoparticles.

Gas sensors can be influenced by substances other than a target substance, particularly humidity. This reduces accuracy and selectivity.

Monitoring of substances such as NO₂ is desirable to keep track of air pollution, particularly in towns and cities. Existing systems use apparatus that samples air over relatively long periods and needs to be collected for detailed analysis in a laboratory. Such systems can provide high accuracy but are expensive and time consuming to operate/collect and cannot provide real time measurements. Sensors are available that rely on reaction between target substances such as NO₂ and metal oxide materials, but these devices require the metal oxide materials to be heated, either to drive a desired reaction during measurements or to clean the materials after measurements. These sensors thus consume high power and cannot easily be left for long periods due to the need to replace power sources such as batteries.

Some nanomaterial structures have been used to measure gases at low concentrations, amongst them carbon nanomaterials. An example is described in Llobet, E. Gas sensors using carbon nanomaterials: A review. Sensors and Actuators B: Chemical 179, 32-45 (2013). While graphene and carbon nanotubes can measure low concentrations in their pristine form they are not selective (see Melios, C. et al. Detection of ultra-low concentration NO2 in complex environment using epitaxial graphene sensors. ACS sensors (2018) and Valentini, L. et al. Sensors for sub-ppm NO 2 gas detection based on carbon nanotube thin films. Applied Physics Letters 82, 961-963 (2003)).

It is an object of the invention to provide an improved sensor or filter or other device using a porous material and/or more efficient manufacturing methods for producing the same.

According to an aspect of the invention, there is provided a method of manufacturing a sensor, comprising: providing a donor material on a support substrate, the donor material comprising carbon or a carbon compound; providing a collecting substrate; and illuminating the donor material with laser radiation, wherein the illumination is such that a porous material comprising carbon is formed on the collecting substrate, wherein: the collecting substrate comprises an electrode arrangement configured to provide an output dependent on an electrical property of a portion of the porous material.

The method allows a porous form of carbon suitable for use in a sensor comprising an electrode arrangement to be manufactured in a reliable and reproducible manner. The method of formation of the porous material is particularly well suited to manufacturing sensors because the porous material can be formed directly on a substrate under ambient conditions (rather than vacuum conditions) and in a geometry which can be used in a sensor without significant further manipulation of the porous material (e.g. transfer of the porous material from one surface to a different surface). For example, the porous material can be spread over a region containing the electrode arrangement that is wide enough for the porous material to perform its function without providing any movement of the collecting substrate during the deposition (although this can be done if desired).

In an embodiment, the porous material acts as a chemiresistor.

In an embodiment, the porous material comprises a three-dimensional network with elongate connecting structures formed from carbon, wherein the elongate connecting structures are not tubular. The network makes available a large specific surface area in comparison with other forms of carbon, facilitating high sensitivity of sensors.

In an embodiment, the layer of donor material is illuminated by the laser radiation through the collecting substrate. This geometry conveniently allows the same illumination system (e.g. laser source and optics) to be used efficiently both to process the collecting substrate (e.g. to laser ablate a pattern in a layer of metal on the collecting substrate that is to be used as an electrode arrangement in a sensor) and to form the porous material on the collecting substrate (e.g. on the electrode arrangement).

In an embodiment, the illumination of the donor material with the laser radiation is performed with a focal point of the laser radiation positioned nearer to the surface of the collecting substrate facing the donor material, or, where provided, nearer to the surface of the deflection substrate facing the donor material, than to the donor material on the support substrate. The inventors have found that this approach improves the efficiency with which the porous material is formed on the collecting substrate. Focusing the laser near to the surface of the collecting substrate prevents build up of carbon material in the region of the collecting substrate through which the laser is passing to reach the donor material. This helps to maintain reliable and constant fluence at the donor material while avoiding excessive heating of the region of the collecting substrate through which the laser is passing to reach the donor material (which could spread by conduction to regions where the porous material is being deposited, causing damage to the porous material or unwanted release of porous material from the collecting substrate). At the same time, the reduced fluence that occurs due to spreading of the laser beam at the slightly out of focus beam spot on the donor material is suitable for providing efficient transfer of the donor material onto the collecting substrate and transformation to the porous form of carbon that is observed.

In an embodiment, the method comprises laser ablating a layer of metal formed on the collecting substrate to form at least part of the electrode arrangement, wherein: the illumination of the donor material is performed through the collecting substrate after the formation of the at least part of the electrode arrangement. This approach conveniently allows the same illumination system (e.g. laser source and optics) to be used efficiently both to form an electrode arrangement on the collecting substrate and to form the porous material on the electrode arrangement.

In an embodiment, the method comprises depositing an additional material onto the porous material. The additional material can change the response of the sensor to a target substance, thereby improving selectivity.

In an embodiment, the amount of additional material deposited is controlled to be in a cross-over regime defined so as to include a range of amounts of the deposited additional material within 25% of a cross-over point between where the resistivity of the porous material is observed to increase as a function of concentration of a reference substance in an atmosphere around the porous material and where the resistivity of the porous material is observed to decrease as a function of concentration of the reference substance in the atmosphere around the porous material.

In an embodiment, the amount of additional material deposited is controlled to be in a cross-over regime separating a first regime and a second regime, wherein: the first regime corresponds to a range of amounts of the additional material in which a dependence of the electrical resistivity of the porous material on a concentration of a reference substance in an atmosphere around the porous material is dominated by an interaction between the reference substance and carbon in the porous material; and the second regime corresponds to a range of amounts of the additional material in which a dependence of the electrical resistivity of the porous material on a concentration of the reference substance in the atmosphere around the porous material is dominated by an interaction between the reference substance and the additional material deposited on the porous material. This approach allows a sensitivity of the sensor to the reference substance to be greatly reduced. In an embodiment, the reference substance comprises water. Operating the sensor in the cross-over regime thereby reduces a sensitivity of the sensor to humidity.

In an embodiment, a deflection substrate is provided facing the donor material and the collecting substrate; and the illumination of the donor material with laser radiation comprises scanning a laser spot along a scanning path over the donor material, the scanning path being such that the porous material comprising carbon is formed on the collecting substrate from carbon expelled from the donor material in the wake of the scanning laser spot. The inventors have found this approach to be particularly convenient to implement and produces a high quality porous material, as well as allowing large areas to be covered by the porous material with high efficiency.

According to an aspect, there is provided a sensor for measuring a target substance, comprising: an electrode arrangement configured to provide an output dependent on an electrical property of a portion of a porous material, wherein: the porous material comprises a three-dimensional network with elongate connecting structures formed from carbon, wherein the elongate connecting structures are not tubular.

According to an aspect, there is provided a method of manufacturing a filter, comprising: providing a donor material on a support substrate, the donor material comprising carbon or a carbon compound; providing a collecting substrate; and illuminating the donor material with laser radiation, wherein the illumination is such that a porous material comprising carbon is formed on the collecting substrate.

According to an aspect, there is provided a filter comprising a porous material, the porous material comprising a three-dimensional network with elongate connecting structures formed from carbon, wherein the elongate connecting structures are not tubular.

According to an aspect, there is provided a method of manufacturing a porous material comprising a continuous metallic network, comprising: providing a donor material on a support substrate, the donor material comprising carbon or a carbon compound; providing a collecting substrate; illuminating the donor material with laser radiation, wherein the illumination is such that a porous material comprising carbon is formed on the collecting substrate; and depositing a metal onto the porous material until a continuous metallic network is formed on the porous material, thereby providing a porous material comprising a continuous metallic network.

The method allows a robust porous material to be formed efficiently. The porous material thus formed may be used in a filter or sensor.

According to an aspect, there is provided a method of manufacturing a porous material comprising carbon, comprising: providing a donor material on a support substrate, the donor material comprising carbon or a carbon compound; providing a deflection substrate facing the donor material and a collecting substrate; and scanning a laser spot along a scanning path over the donor material, the scanning path being such that a porous material comprising carbon is formed on the collecting substrate from carbon expelled from the donor material in the wake of the scanning laser spot.

The invention will now be further described, by way of example, with reference to the accompanying drawings, in which:

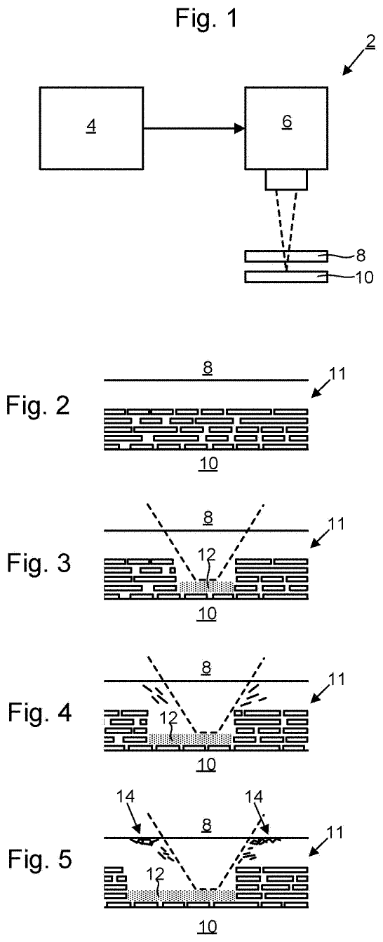

FIG. 1 depicts an apparatus for manufacturing a porous material;

FIGS. 2-5 depict stages in a process for manufacturing a porous material;

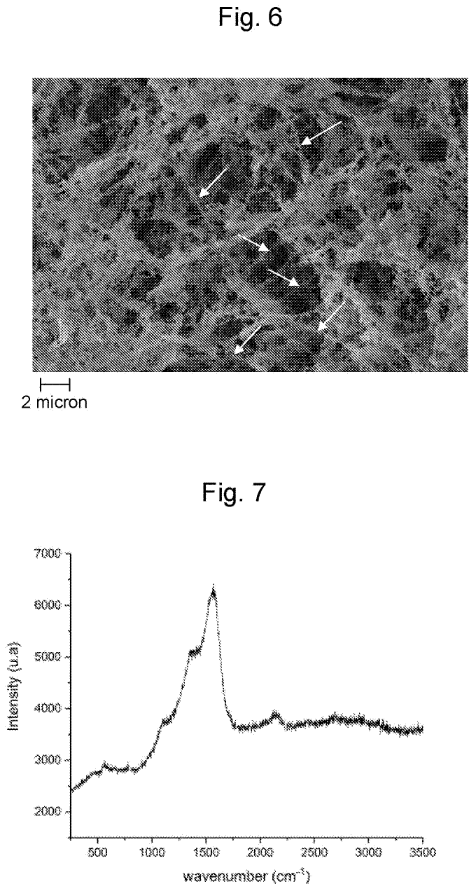

FIG. 6 is a magnified image of the three-dimensional network having elongate connecting structures formed from carbon;

FIG. 7 depicts a Raman spectrum of an embodiment of the porous material;

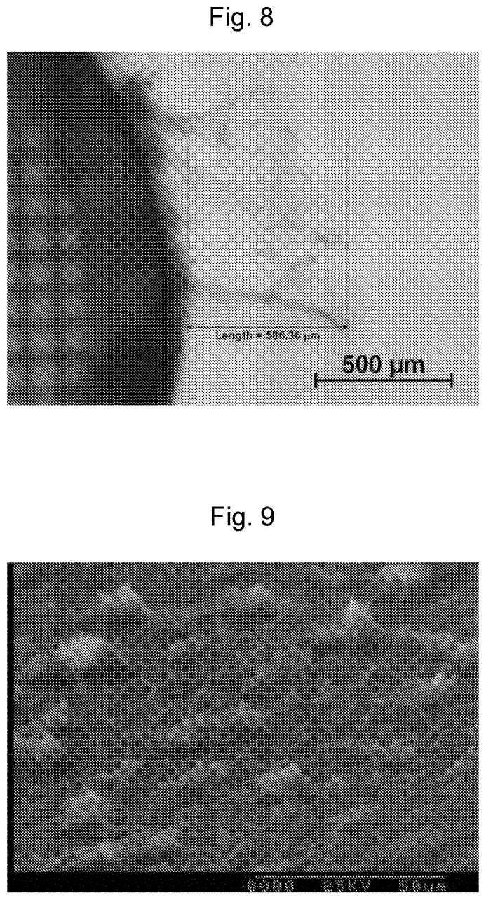

FIG. 8 is an image depicting a characteristic length scale of an elongate connecting structure of an embodiment of the porous material;

FIG. 9 is a magnified view of an example of the porous material formed using graphene as a donor material;

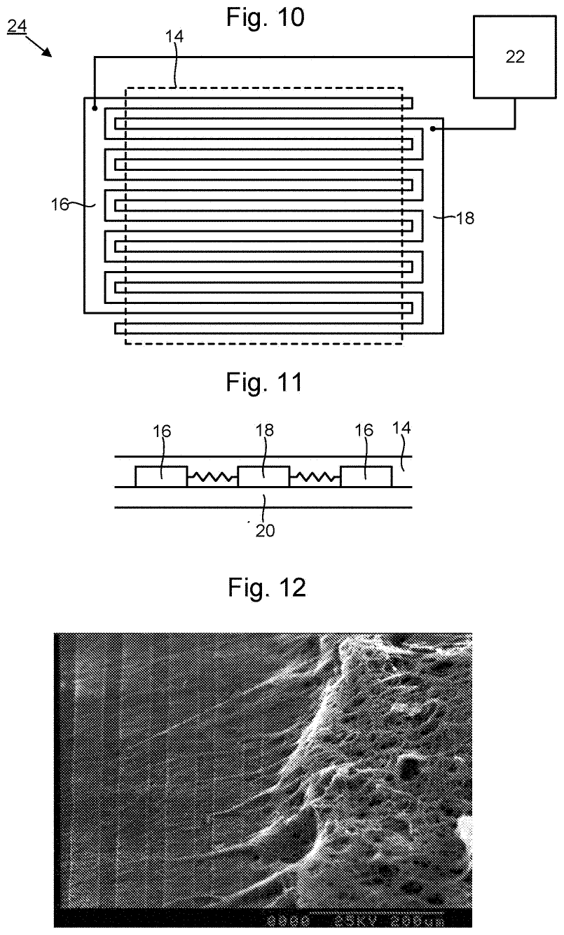

FIG. 10 is a schematic top view of a sensor comprising a plurality of interlocked finger electrodes;

FIG. 11 is a side view of a portion of the sensor of FIG. 10;

FIG. 12 is a magnified image of the porous material formed over a portion of a plurality of interlocked finger electrodes;

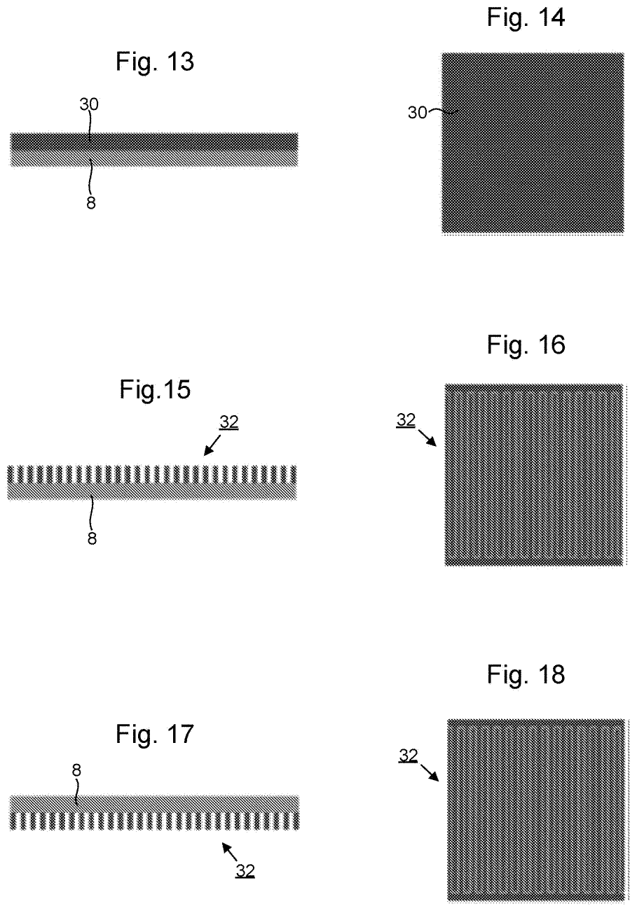

FIGS. 13-24 are schematic side and top views of steps in a method of manufacturing a sensor;

FIG. 25 is a magnified view of an embodiment of the porous material onto which metal particles have been deposited;

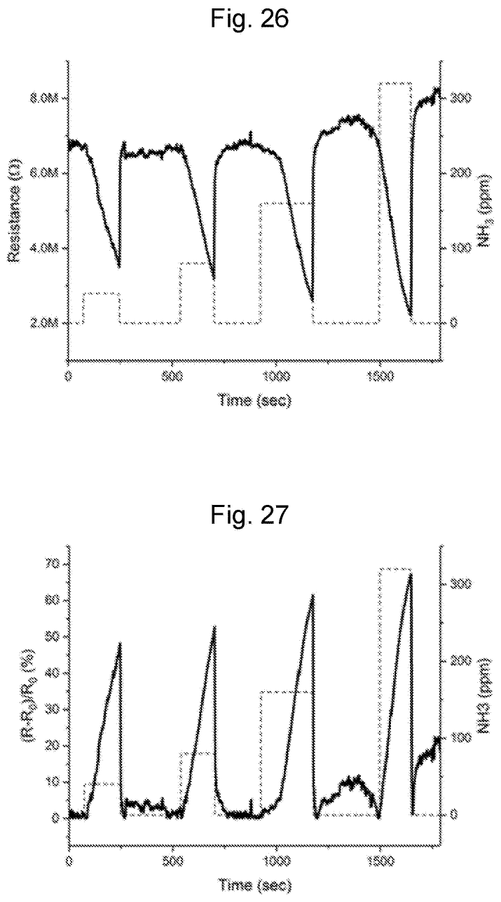

FIG. 26 is a graph showing a variation of a measured resistance through a portion of an embodiment of the porous material in a sensor as a function of time for different concentrations of ammonia applied to the sensor;

FIG. 27 is a graph showing a relative response of the sensor to the ammonia;

FIG. 28 is a graph showing that high response and fast recovery are maintained during long exposure to NH₃;

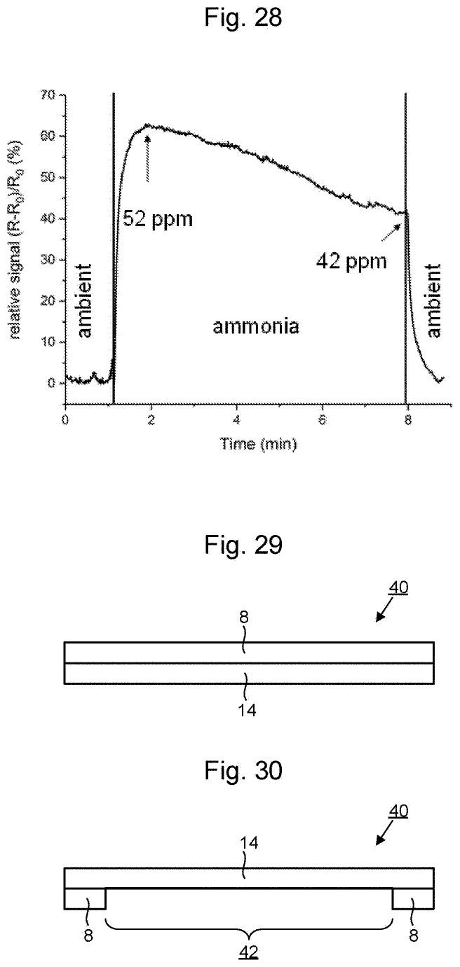

FIG. 29 depicts a filter comprising an embodiment of the porous material supported by a porous collecting substrate;

FIG. 30 depicts a filter formed by selectively removing a portion of the collecting substrate to form a freestanding membrane comprising an embodiment of the porous material;

FIG. 31 depicts sheet resistances of reduced graphene oxide for various fluences and thicknesses;

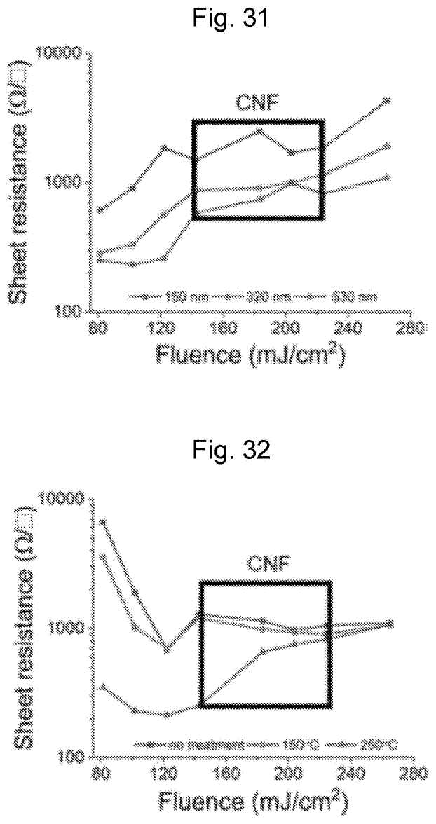

FIG. 32 depicts sheet resistances of reduced graphene oxide for various fluences and different temperature pre-treatments of the graphene oxide;

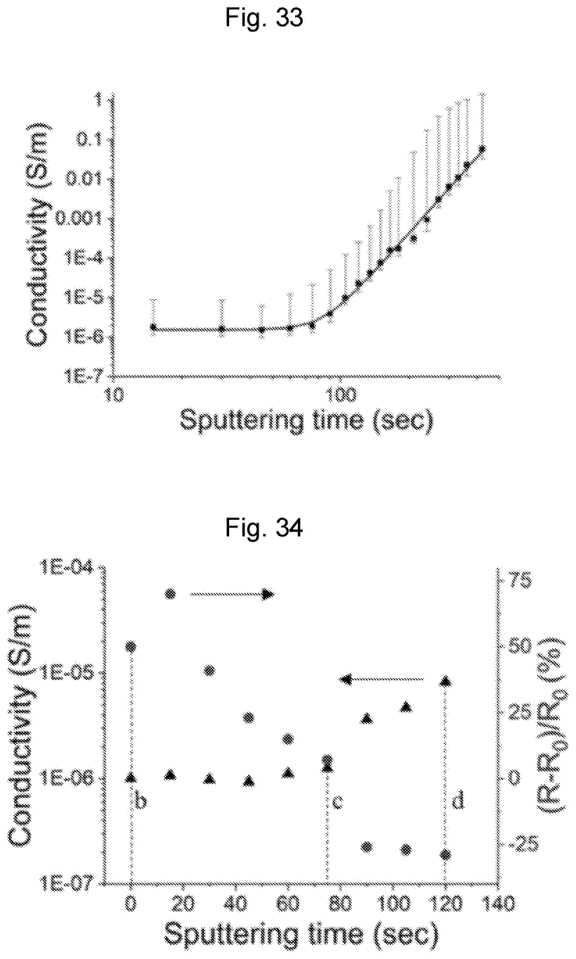

FIG. 33 depicts the result of measurements of conductivity of a porous material comprising carbon as a function of sputtering time of gold onto the porous material;

FIG. 34 is a graph showing the initial conductivity and response (normalized change in resistance) of the porous material to a reduction in humidity from 37%rh to 20%rh for different sputtering times;

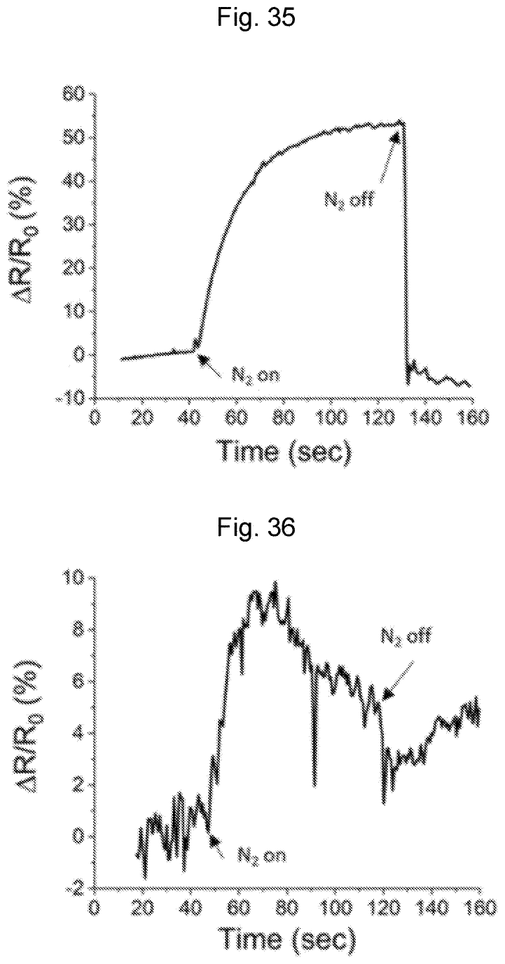

FIG. 35 is a graph showing the time response of an uncoated porous material to a reduction of humidity;

FIG. 36 is a graph showing the time response of a coated porous material in a cross-over regime to a reduction of humidity;

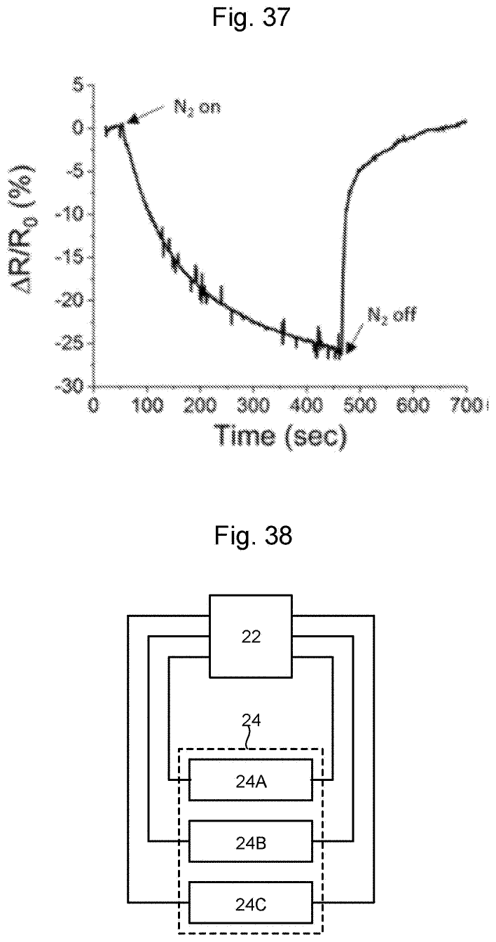

FIG. 37 is a graph showing the time response of a coated porous material in a percolating regime to a reduction of humidity;

FIG. 38 depicts a sensor having a plurality of sensor elements;

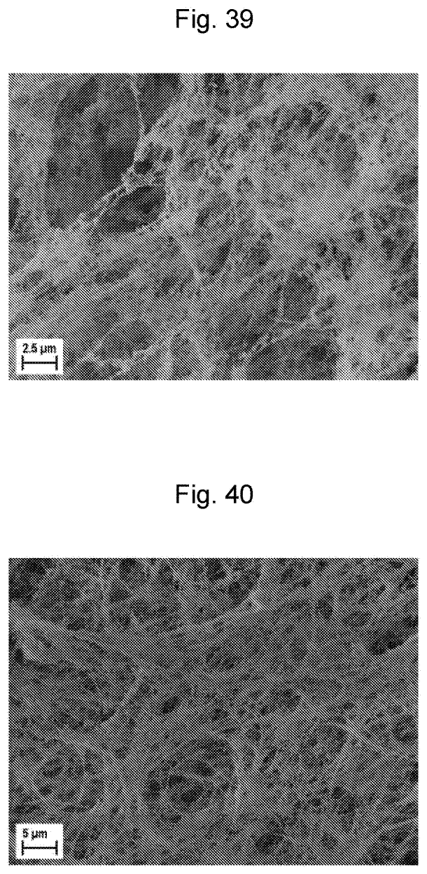

FIG. 39 depicts an SEM image of porous material after 15 s sputtering time of gold onto the porous material;

FIG. 40 depicts an SEM image of porous material after 45 s sputtering time of gold onto the porous material;

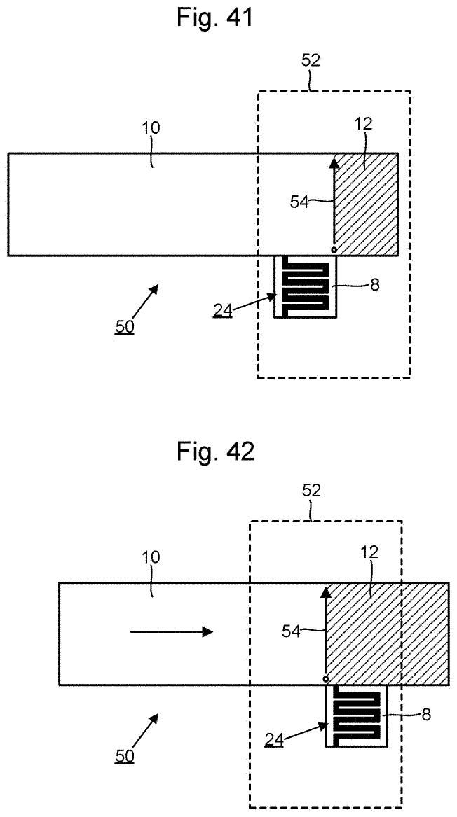

FIGS. 41-42 are schematic top views of an arrangement in which a porous material can be deposited in the wake of a scanned laser spot;

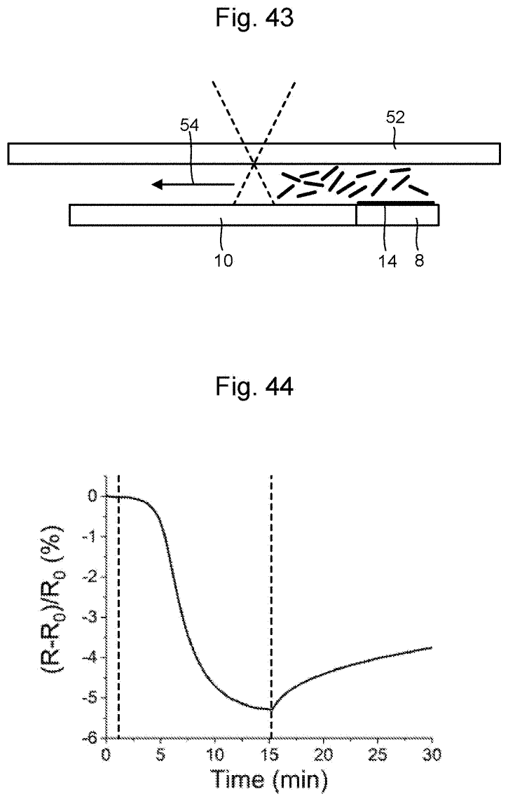

FIG. 43 is a schematic side sectional view of the arrangement of FIGS. 41-42;

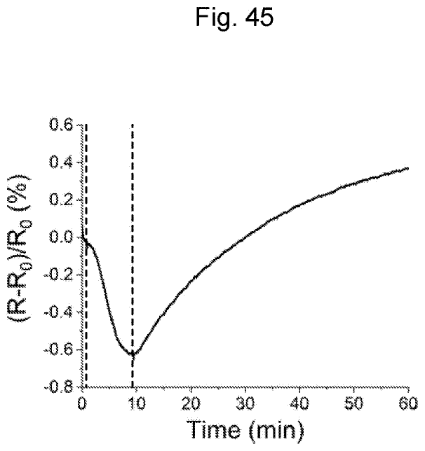

FIGS. 44 and 45 are graphs depicting sensor results obtained using a sensor comprising porous material manufactured using an arrangement of the type depicted in FIGS. 41-43;

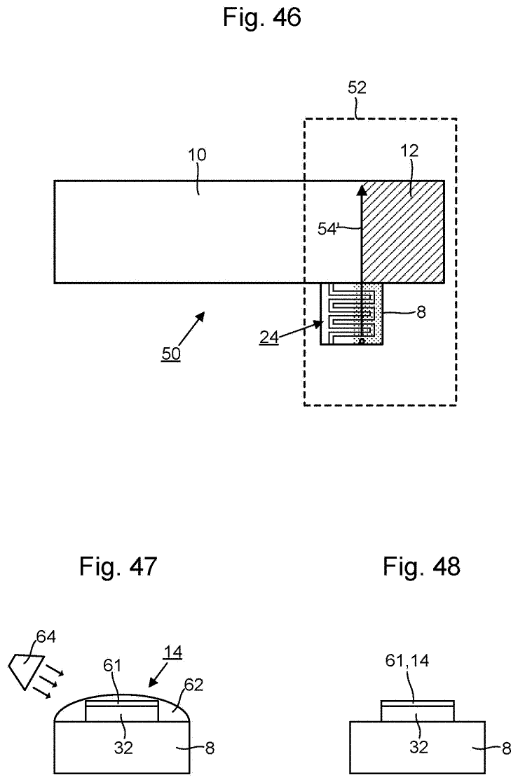

FIG. 46 is a schematic top view of an arrangement in which porous material is deposited in the wake of a scanned laser spot and the scanning laser spot is used to anneal the deposited porous material;

FIG. 47 is a schematic side sectional view showing removal of a second layer of a porous material 14 comprising a first layer and a second layer;

FIG. 48 is a schematic side sectional view showing the arrangement of FIG. 47 after removal of the second layer;

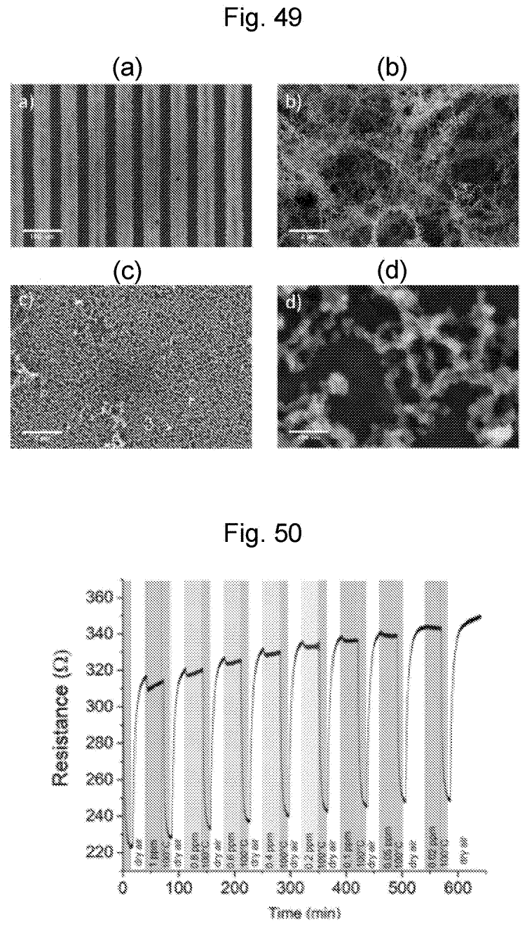

FIG. 49(a)-(d) depict SEM images of different stages of manufacture of an arrangement of the type shown in FIG. 48;

FIG. 50 is a graph depicting variation of a sensor resistance with time during exposure to various concentrations of NO₂;

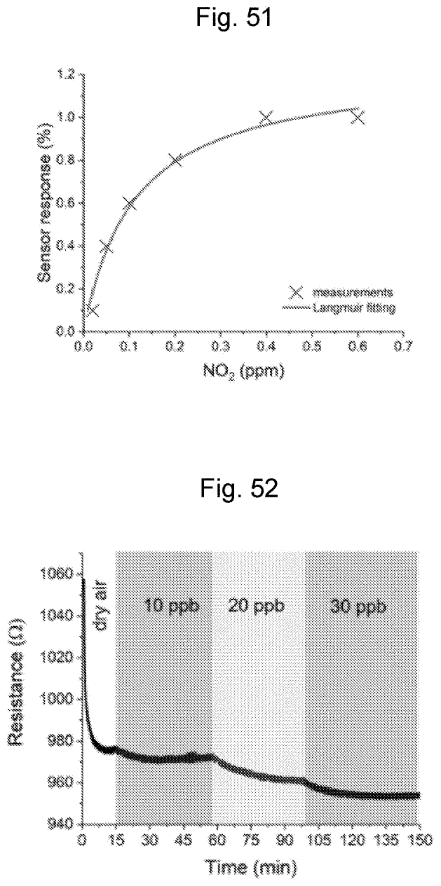

FIG. 51 is a graph showing variation of a % sensor response as a function of NO₂ concentration;

FIG. 52 is a graph showing sensitivity of the sensor to concentrations as low as 10 ppb;

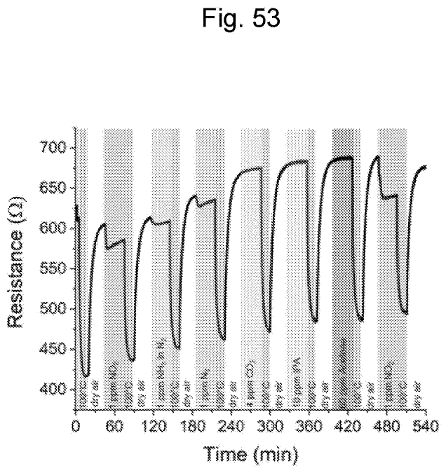

FIG. 53 is a graph showing variation of sensor resistance with time during exposure to different gases;

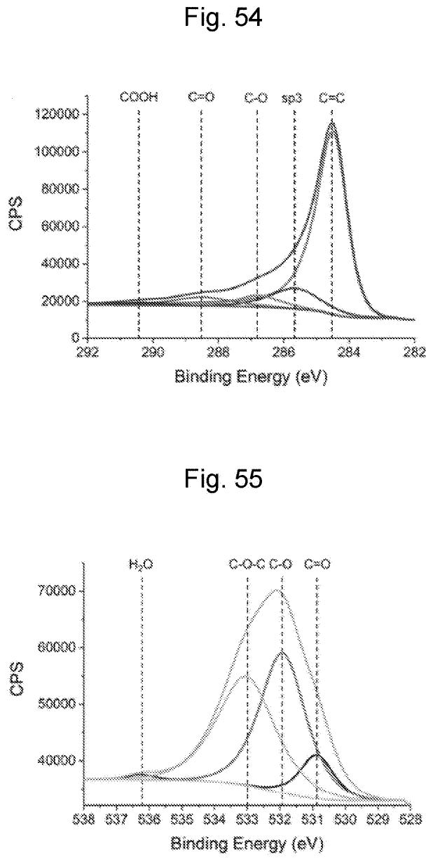

FIG. 54 depicts deconvoluted C1 XPS peaks of porous material comprising carbon; and

FIG. 55 depicts deconvoluted O1 XPS peaks of porous material comprising carbon.

Embodiments of the present disclosure are based on the surprising discovery that a porous material comprising carbon suitable for implementing a sensor or a filter can be created under certain processing conditions involving laser illumination of a donor material comprising carbon (e.g. graphene or graphite) or a carbon compound (e.g. graphene oxide), even under ambient atmospheric conditions (e.g. air at atmospheric pressure).

FIG. 1 depicts an example apparatus 2 for manufacturing the porous material. The apparatus 2 comprises a laser source 4. The laser source 4 outputs laser radiation to a scanning optical system 6. The scanning optical system 6 illuminates a donor material 11 (depicted schematically in FIGS. 2-5) with the laser radiation. In an embodiment the donor material 11 is provided on a support substrate 10. The donor material 11 comprises carbon and/or a carbon compound (and optionally other materials). In an embodiment, the donor material 11 comprises, consists essentially of, or consists of one or more of the following: graphene, graphene oxide, graphite, carbon. The focal point of the laser radiation will typically be positioned near to the donor material in order to provide a suitable fluence at the donor material. The focal point may coincide with the donor material 11 or the support substrate 10 for example (as depicted schematically in FIGS. 2-5). In other embodiments, as will be discussed in further detail below with reference to FIGS. 13-24 and FIGS. 41-43, the focal point may be located significantly above the donor material 11, for example nearer to a collecting substrate or deflection substrate than to the donor material. The process may be performed in air and/or at atmospheric pressure.

In some embodiments, a collecting substrate 8 faces the donor material 11. In such embodiments, the collecting substrate 8 is spaced apart from the donor material 11, for example separated from the donor material by a gap containing gas (e.g. air at ambient temperature and atmospheric pressure). In an embodiment, the gap is less than 5 mm, optionally less than 1 mm, optionally less than 0.5 mm, optionally less than 0.1 mm. The laser source 4 and scanning optical system 6 are configured to illuminate the donor material 11 with laser radiation in such a way that a porous material comprising carbon is formed on the collecting substrate 8. In an embodiment, the donor material 11 is illuminated by the laser radiation through the collecting substrate 8 (i.e. from above in the orientation shown in the FIGS. 2-5). In such embodiments, the collecting substrate 8 may be substantially transparent to the laser radiation (e.g. glass in the case where the laser radiation is infrared). In other embodiments, the donor material 11 is illuminated through the support substrate 10 (i.e. from below in the orientation of the FIGS. 2-5).

In an embodiment, the laser radiation is scanned in a plurality of partially overlapping lines over the donor material 11, for example in a raster scan in which neighbouring parallel scanning lines partially overlap with each other. Each line in the scan overlaps with at least two other lines in a direction perpendicular to the line. The scanning may be achieved by moving either or both of the radiation beam and the support substrate 10. FIGS. 2-5 depict schematic magnified views of a portion of the collecting substrate 8, support substrate 10, and donor material 11 at different stages during formation of the porous material using a scanning approach of this type. In one particular embodiment, the support substrate 10 is moved linearly in a first direction (e.g. to the left in FIGS. 2-5) while the laser radiation is scanned in a second direction, perpendicular to the first direction (e.g. into and/or out of the page in FIGS. 2-5), either simultaneously or at different times (e.g. in a step and scan mode).

FIG. 2 depicts a stage before illumination by the laser. A layer (optionally uniform) of the donor material 11 is present on the support substrate 10. The thickness of the layer should typically be higher than 200 nm. No porous material is present on the underside of the collecting substrate 8.

FIG. 3 depicts interaction between the laser radiation (indicated schematically by the beam profile depicted by broken lines) and the donor material 11 during scanning of the laser radiation along a line oriented into the page. The donor material 11 is transformed by the laser radiation in an interaction region 12. The interaction may comprise ablation.

FIG. 4 depicts a stage after the laser radiation has been scanned several times (e.g. less than 10 times) over the donor material 11. Transfer of material from the support substrate 10 to the collecting substrate 8 starts to take place. The support substrate 10 has been moved to the left relative to the collecting substrate 8 to provide fresh donor material to be converted by the laser into the porous material 14.

FIG. 5 depicts a stage after the laser radiation has been scanned over the donor material 11 a sufficient number of times (e.g. greater than 10 times) that formation of the porous material 14 on the underside of the collecting substrate 8 is observed.

The porous material 14 comprises a three-dimensional network having elongate connecting structures formed from carbon. The elongate connecting structures may be described as strings or web-like structures. The elongate structures are not tubular or carbon nanotubes. The network does not have long range order and may be described as amorphous (although some short range order may exist). FIG. 6 is a magnified image of the porous material. Example elongate connecting structures are indicated by arrows. Without wishing to be bound by theory, it is believed the connecting structures are formed predominantly from sp² carbon.

FIG. 7 depicts a Raman spectrum of porous material produced according to the method. The important peaks are at 1366 cm⁻¹ (D-peak) and 1556 cm⁻¹ (G-peak). The peak at around 1100 cm⁻¹ is caused by the collecting substrate on which the porous material was provided. The spectrum shows that the porous material is a hybrid or mixture of nanocrystalline and amorphous carbon (due to the G-peak position at 1556 cm⁻¹). It is found that the G-peak position is located at 1556 ±2 cm⁻¹ for a range of embodiments of porous material produced according to methods disclosed herein.

The intensity ratio between the two peaks (D/G) in FIG. 7 indicates that the porous material has roughly 10% sp³ bonds and the rest is sp² bonds. In embodiments, it is found that the porous material comprises 5-15% sp³ bonds (with the rest sp² bonds), optionally 8-12% sp³ bonds (with the rest sp² bonds), optionally substantially 10% sp³ bonds (with the rest sp² bonds).

The characteristic lengths of the elongate connecting structures, and their aspect ratios of length to width, are significantly higher than those of any comparable structures present in any form of carbon known to the inventors. In embodiments of the porous material, it is typically found, for example, that at least one elongate connecting structure has (and typically very many have) an unbranched length of 50 microns or more, optionally 100 microns or more, optionally 200 microns or more, optionally 500 microns or more. FIG. 8 shows a magnified image of a portion of a porous material produced using the process that comprises an elongate connecting structure with a length greater than 500 microns. A branching point appears to be present towards the middle of the elongate connecting structure, such that the elongate connecting structure comprises two unbranched lengths that are each greater than 200 microns.

The porous material is electrically conductive. In an embodiment, the porous material has a resistivity of less than 10 MΩ/sq at 298 K, optionally less than 6 MΩ/sq at 298 K, optionally less than 3 MΩ/sq at 298 K.

In an embodiment, the laser radiation comprises infrared radiation (e.g. using a fibre laser at 1064 nm) provided by an infrared laser. In an embodiment, the laser is a pulsed solid state laser. In an embodiment a nanosecond-pulsed laser is used. In other embodiments, laser radiation outside of the infrared may be used, for example green laser light, or UV.

In an embodiment, the donor material 11 comprises, consists essentially of, or consists of graphene oxide and the laser radiation is provided by an IR laser (e.g. 1064 nm) operating in a fluence window of 140-220 mJ/cm². FIG. 31 depicts measurements of sheet resistance of reduced graphene oxide during the laser treatment for different fluences and different initial thicknesses of graphene oxide. The inset shows the fluence range in which formation of the porous material comprising carbon is observed. FIG. 32 depicts measurements of sheet resistance of reduced graphene oxide during the laser treatment for different fluences and different temperature pre-treatments of the graphene oxide. The inset shows the fluence range in which formation of the porous material comprising carbon is observed. FIGS. 31 and 32 demonstrate that the range of fluences in which the porous material comprising carbon can be formed is relatively insensitive to both the initial thickness of the graphene oxide and any temperature pre-treatments that are applied to the graphene oxide.

The image shown in FIG. 6 depicts porous material formed using graphene oxide as the donor material 11. The donor material 11 may, for example, be formed by spraying graphene oxide platelets onto a glass support substrate 10 or by drop casting. The thickness of the graphene oxide layer thus formed was greater than 200 nm. The interaction between the laser radiation and the donor material 11 in this example causes graphene oxide to be reduced to reduced graphene oxide.

In an embodiment, the donor material 11 comprises, consists essentially of, or consists of graphene. The image shown in FIG. 9 depicts porous material formed using graphene as the donor material 11.

In an embodiment, the donor material 11 comprises, consists essentially of, or consists of graphite.

In an embodiment, a sensor 24 is manufactured using the porous material 14. An example of such a sensor 24 is discussed below with reference to FIGS. 10-24. The sensor 24 provides an output that is dependent on an interaction between a target substance and the porous material 14. The porous material 14 may be formed using any of the processes disclosed herein. The large specific surface area made available by the porous material 14 allows relatively large amounts of the target substance to interact with the porous material 14, thereby facilitating high measurement sensitivity. In an embodiment, the porous material 14 behaves as a chemiresistor material. The target substance may for example bond with the porous material, for example via covalent bonding or hydrogen bonding. The interaction between the target material and the porous material 14 may cause a change in an electrical property, such as resistivity, of the porous material 14. The change in the electrical property (e.g. resistivity) may be measured by the sensor 24 and used as the basis for an output provided by the sensor 24. In an embodiment, the sensor 24 comprises an electrode arrangement configured to provide an output dependent on an electrical property (e.g. resistivity) of a portion of the porous material, for example a portion providing an electrical path between different electrodes. In the example of FIGS. 10-24, the sensor 24 comprises an electrode arrangement comprising a first set of finger electrodes 16 and a second set of finger electrodes 18 provided on a sensor substrate 20. The first and second sets of finger electrodes 16,18 are interlocked with each other. The finger electrodes may be separated from each other by about 50 microns or less for example. A layer of the porous material 14 is provided over the sets of finger electrodes 16,18 and provides an electrical path between the finger electrodes 16 and the finger electrodes 18. A control device 22 drives an electrical current through the porous material 14 via the finger electrodes 16 and 18 and thereby obtains information related to the resistivity of the porous material 14. The porous material 14 between each pair of electrodes effectively acts as a resistor, as depicted schematically by the resistor symbols in the side view of FIG. 11). A change in the resistivity of the porous material 14 can be detected by the control device 22 and used to deduce the presence or absence of the target substance and/or to determine an amount (concentration) of the target substance. FIG. 12 is an image showing an incomplete layer of the porous material 14 adjacent to finger electrodes to illustrate the relative scale of the layer of porous material and a typical finger electrode arrangement.

FIGS. 13-24 depict steps in an example method of manufacturing a sensor 24.

FIGS. 13 and 14 respectively depict side and top views of an initial step in which a metal layer 30 is provided on a substrate 8. The substrate 8 is substantially transparent to the laser radiation used in subsequent steps. In the case of an infrared laser, for example, the substrate 8 can be formed from glass for example.

FIGS. 15 and 16 respectively depict side and top views of a subsequent step in which the metal layer 30 is patterned. The patterning may be performed by laser ablation for example. The laser ablation may be performed using the same laser apparatus that is used in later steps to form the porous material. In the embodiment shown the metal layer 30 is patterned to form an electrode arrangement 32. The electrode arrangement 32 may comprise any of the configurations discussed above, including for example a plurality of interlocked finger electrodes.

FIGS. 17 and 18 respectively depict side and top views of a subsequent step in which the substrate 8 is inverted so that the electrode arrangement is positioned on a side of the substrate 8 that is opposite to the laser.

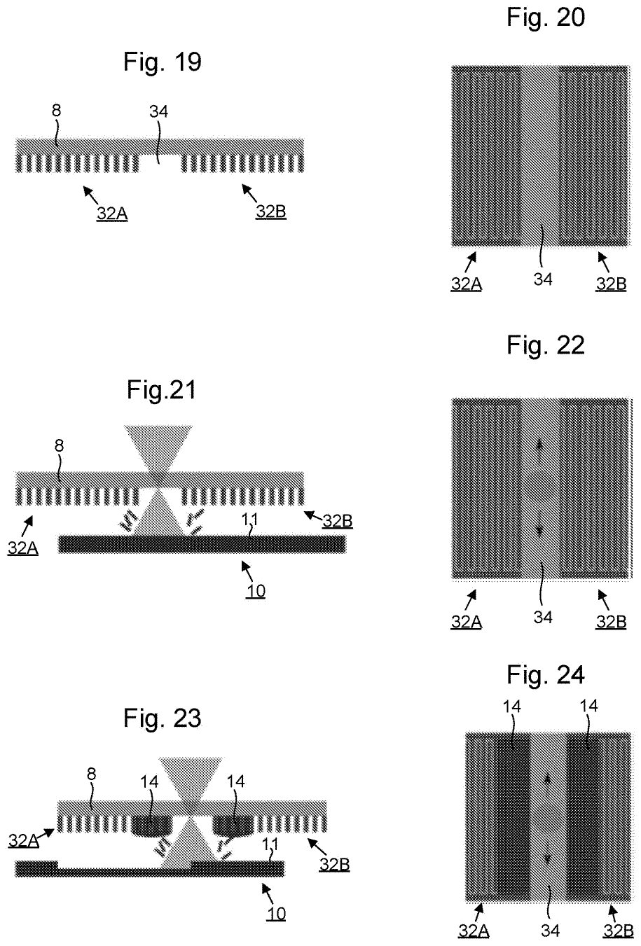

FIGS. 19 and 20 respectively depict side and top views of a subsequent step in which the electrode arrangement 32 is split into two disconnected electrode arrangements 32A and 32B by removing metal from a band 34 separating the two disconnected electrode arrangements 32A and 32B. In an embodiment the metal is removed by laser ablation. The band may have a width of about 68 microns for example and be formed with a laser spot size of 34 microns. Two passes of the laser at different focal heights may be used to remove the material in the band region completely. It is convenient to form the band 34 after the substrate 8 has been inverted (rather than before, as part of the patterning of the metal layer 30 of FIGS. 15 and 16) because this avoids the need to align the laser before formation of the porous material 14 on the substrate 8 (the laser is already aligned with the band 34). Manufacturing speed is thereby enhanced.

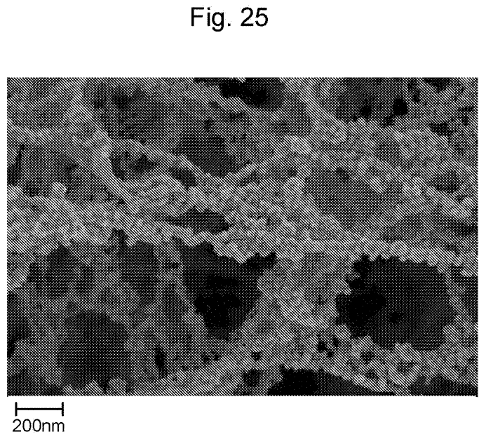

FIGS. 21 and 22 respectively depict side and top views of a subsequent step in which donor material 11 (e.g. graphene oxide, graphene, and/or graphite) on a support substrate 10 is illuminated by laser radiation. The donor material 11 is provided within about 1 mm of the lower surface of the electrode arrangement 32 on the substrate 8. As described above, the illumination is such that a porous material 14 comprising carbon begins to be formed on the substrate 8, in this case covering a portion of the electrode arrangement 32 present on the underside of the substrate 8 (labelled at a more advanced stage in FIGS. 23 and 24). The illumination of the donor material 11 is performed through the band 34 separating the two disconnected electrode arrangements 32, thereby providing a transparent path for the laser radiation. The laser radiation may be scanned along the band 34 in a straight line.

FIGS. 23 and 24 respectively depict side and top views of the process at a subsequent stage when the support substrate 10 has been moved linearly in a first direction (to the left) and the laser radiation has been scanned several times in a second direction (into and/or out of the page) perpendicular to the first direction (e.g. to perform the raster scan of overlapping scanning lines discussed above). The relative movement of the support substrate 10 ensures that the laser gradually encounters fresh donor material 11 as needed to provide the porous material 14 on the electrode arrangement 32. In a particular embodiment the support substrate 10 is moved by a step size of 7 microns in between each line scan of the laser to bring fresh donor material 11 underneath the laser spot. Other step sizes can also be used. The porous material 14 naturally spreads out over the electrode arrangement 32 such that lateral movement of the electrode arrangement 32 relative to the laser beam (i.e. left or right in the orientation shown), or relative to a scanning line of the laser beam, may not be necessary to ensure that a sufficient portion of the electrode arrangement 32 is covered for the sensor to operate as intended. However, in other embodiments the substrate 8 may be moved if it is required to deposit the porous material 14 over a larger area.

As shown in FIGS. 21 and 23 the illumination of the donor material 11 with the laser radiation is performed in this embodiment with a focal point of the laser radiation positioned nearer to the surface of the substrate 8 facing the donor material 11 than to the donor material 11 on the support substrate 10. In this particular example the focal point coincides with the surface of the substrate 8 facing the donor material 11.

In an embodiment the target substance for the sensor 24 comprises a gas, in which case the sensor 24 may be referred to as a gas sensor. In an embodiment, the target substance comprises ammonia (NH₃). A wide range of other gases could also be detected, including for example NO₂ and/or formaldehyde. The porous material can be functionalised to enhance selectively and/or sensitivity and/or to lower the limit of detection. Functionalisation can be implemented with a wide range of materials deposited on the porous material, using a wide range of deposition processes (e.g. sputtering or evaporation).

Thus, an additional material may be deposited onto the porous material. The additional material may be used for functionalization or for other purposes (e.g. to strengthen the porous material or to change a porosity or filtering property of the porous material). The additional material may comprise a metal or non-metal. The additional material may be deposited in such a way as to form a continuous network of the additional material. The continuous network of the additional material may provide enhanced mechanical robustness in comparison with the porous material before deposition of the additional material. The continuous network may comprise a continuous metallic network when the additional material comprises a metal. This may be referred to as metallisation. The additional material may be added in layers. For example, a metal (e.g. gold) could be deposited in a first step to form a continuous metallic network and a metal oxide or other material could be deposited onto the metallic network (e.g. to enhance sensing selectivity and/or sensitivity) in a subsequent step. Alternatively or additionally, the additional material may comprise a biologically active material such as an antibody. FIG. 25 is an image depicting a portion of porous material after sputtering of a metal onto the porous material. The elongate connecting structures formed from carbon act as a scaffold to support the deposited metal. By selecting different deposited materials the porous material can be adapted to be suitable for detecting different target substances when used in a sensor (as described above), or to have different filtering properties when used as a filter (as described below).

Performance of an example sensor 24 (with no material deposited on the porous material) measuring ammonia (NH₃) as the target substance is illustrated in FIGS. 26-28. FIG. 26 is a graph showing a variation of a measured resistance through a portion of the porous material 14 in the sensor 24 as a function of time. FIG. 27 is a graph showing variation of a relative response of the sensor (a difference between the resistance R and a baseline resistance R₀, normalized by the baseline resistance R₀). During the time period of the measurement, the sensor 24 was exposed to four different concentrations of NH₃ (as indicated by the broken line bars and the vertical scale on the right hand side). The sensor 24 responded immediately to the NH₃ in each case. Furthermore, the size of the response varies according to the concentration of the NH₃, thereby providing the basis for not only detecting presence or absence of the NH₃ but also providing a sensitive measure of the amount of NH₃ present. A 48% relative change to 40 ppm NH₃ is observed in dry air. Instant recovery is observed when flushed with ambient air (i.e. between each broken line bar or pulse of NH₃). FIG. 28 shows that the high response and fast recovery are maintained during long exposure to NH₃.

In a further embodiment, a method of manufacturing a filter is provided in which the porous material 14 is formed on a collecting substrate 8 according to any of the embodiments discussed above and in which the collecting substrate 8 itself is porous. Material to be removed from a fluid flow can pass through the porous collecting substrate 8 but is trapped by the porous material 14. A schematic side view of such a filter 40 is depicted in FIG. 29. In an embodiment, the method further comprises depositing a metal onto the porous material 14 to provide an arrangement such as that shown in FIG. 25. The deposited metal acts to increase the mechanical stability of the porous material 14 and/or can be used to tune the filtering properties of the filter 40. In a variation on this embodiment, as depicted in FIG. 30, the collecting substrate 8 may be removed (e.g. by lithography and etching) to form a freestanding membrane 42 comprising the porous material 14. In this case the collecting substrate 8 does not need to be porous itself

Porous materials comprising carbon can be made in various morphologies and with different methods. Examples having certain advantages are described in the present disclosure. Further examples are described in Inagaki, M.; Qiu, J.; Guo, Q. Carbon 2015, 87, 128-152, Rode et al. (Rode, A. V.; Hyde, S.; Gamaly, E.; Elliman, R.; McKenzie, D.; Bulcock, S. Applied Physics A: Materials Science & Processing 1999, 69, S755-S758), and Henley, S.; Carey, J.; Silva, S.; Fuge, G; Ashfold, M.; Anglos, D. Physical Review B 2005, 72, 205413, where a theoretical mechanism of formation is described in detail. It is thought that, at least for some forms of the porous material comprising carbon, a cluster assembled fractal carbon foam (an example of a porous material comprising carbon) is formed during laser ablation of a carbon target with similar properties to Schwarzites. The formation was described as a diffusion limited aggregation process which forms a fractal structure on a small scale (>100 nm) ending up in a web-like appearance at larger scales (>10 μm). Carbon sp³ bonds, mostly located on the surface of the nanoparticle, form the bonding between the individual clusters. The carbon foam structure had between 15% and 45% of sp³ bonds at the interface between the clusters giving the foam a diamond-like structure. It has been proposed that the initial cluster formation involves three different phenomena, namely: collisions of carbon atoms in the plume created by the laser; direct ablation of clusters of the target material, and the collision of smaller clusters during the ablation. The clusters then grow by the attachment of single-atoms to larger clusters. The formation occurs outside of the initial shock wave created by the laser when ablating the target, where the carbon starts to diffuse. Deposition within the shock wave would lead to a dense graphitic film, whereas outside of the shock wave the cluster formation occurs.

As described above, embodiments of the present disclosure may involve deposition of an additional material onto the porous material. The additional material may be used for functionalisation of the porous material, for example to make the porous material more or less sensitive to a particular substance. In some embodiments, the functionalisation may cause the resistance of the porous material to react differently to the presence of certain substances in the atmosphere around the porous material. This effect can be exploited in the context of a sensor to make the sensor more sensitive to certain target substances and/or to reduce a background signal from substances that are not of interest (e.g. humidity).

The inventors have found that the resistivity of the porous material and the responsiveness of the porous material to target substances varies significantly as a function of the amount (e.g. film thickness) of the additional material that is added. These effects are exemplified in the following discussion by reference to the addition of gold particles to a porous material comprising carbon by sputtering. The same principles will apply, however, to particles of different composition and/or particles deposited using other techniques.

FIG. 33 depicts the result of measurements of conductivity (inversely proportional to resistivity) of a porous material comprising carbon as a function of sputtering time of gold onto the porous material. The sputtering time defines the amount of gold that has been deposited. While film thickness is poorly-defined for such porous structures, thickness measurements were performed with the focus drive of an optical microscope and an averaged value (film thickness of 100 μm) was used for conductivity calculations. The initial conductivity of the unmodified porous material was 3 μS/m. Upon coating with gold this increased to 58 mS/m after 7 min sputtering time. Multiple regimes in the conductivity data of FIG. 33 are observed. Below 60 s sputtering time the conductivity does not significantly vary. SEM images of the deposited material at 15 s (FIG. 39) and at 45 s (FIG. 40) showed that the porous material maintained its “fluffy” structure, albeit sparsely decorated with gold nanoparticles. Around 60 to 70 s the conductivity begins to increase, with the data beyond that point resembling a power law dependence.

This behaviour is characteristic of a percolating system, with the parameter space (sputtering time) separated into below and above percolation regimes. Once the density of gold on the porous material surpasses the percolation threshold the gold coating begins to dominate the conductivity. The data of FIG. 33 are fitted using a percolation scaling of the form σ=A(t−t_{c})ⁿ+σ₀; where σ is the conductivity; A is a pre-factor; t is the sputtering time; t_{c} is the percolation threshold; n is the conductivity exponent; σ₀ is the baseline conductivity. The percolation threshold sputtering time is found to be 1 min, equivalent to a 3 nm thick gold layer on a flat surface.

FIG. 34 shows the initial conductivity and response of the porous material to a change in humidity from 37%rh to 20%rh (i.e. a decrease in humidity) at different sputtering times. FIG. 35 shows the time response of the uncoated pristine porous material (corresponding to point “b” in FIG. 34). “N₂ on” corresponds to turning on of an N₂ flushing gas, which decreases the humidity. “N₂ off” corresponds to turning off of the N₂ flushing gas, which restores the initial humidity. We note that below the percolation threshold the sample resistivity (conductivity) increases (decreases) with decreasing humidity, with a rapid relaxation to the initial state once the initial humidity is restored. Treating the signal as a rising followed by a decaying exponential, we find time constants (t90, the time required to achieve 90% of the limiting response) of 13 s for the water desorption and <1 s for the subsequent water reabsorption. Above the percolation threshold the opposite effect is observed, with water desorption and adsorption occurring over significantly longer timescales; 32 s and 65 s for the desorption and recovery, respectively. Very close to the percolation threshold, the two apparently competing behaviours “cancel out” to give an extremely low response to the humidity change. FIG. 36 shows an analogous measurement to FIG. 35 close to the gold percolation threshold (corresponding to point “c” in FIG. 34). The observed variation with humidity is very small. FIG. 37 shows the response within the percolating regime (corresponding to point “d” in FIG. 34). The variation with humidity is observed to be opposite in sign to the variation observed in FIG. 35 and much larger than the variation observed in FIG. 36.

The above measurements show how the porous material can change its sensing behaviour from a carbon response to a metallic response. A decrease in humidity leads to a decrease in conductivity for the bare porous material as the water layer on the carbon becomes discontinuous and slows down the H₂O—H₃O⁺ transfer. This ionic transfer is the main water sensing mechanism in carbon-based systems. By contrast, where the conductivity is dominated by the gold after sufficient gold has been added, the adsorbed water induces depletion zones in the gold where it is attached. Removing water from the surface of the gold by reducing the humidity reduces the influence of the depletion zones so the conductivity increases.

A gold film sputtered directly onto electrodes (without the supporting porous material) with a similar resistance as the gold and carbon porous material of FIG. 37 results in a response of only 7% to humidity in the same experimental conditions. This effect can be attributed to the increased surface area available for the water to interact with the gold in the network formed by the porous material and the increased influence of the depletion zones due to the nanometric size of the percolating gold particles.

The response to humidity observed in the porous material to which the gold has been added is high, with a maximum response of 70% to a change of 18%rh for the uncoated porous material and a response of 30% after the gold has been added. The response time of the uncoated porous material is quicker than the response time of the porous material after gold has been added, but both have an excellent recovery time. While it may be expected that precisely at the percolation threshold the system should not be sensitive to a change in humidity, the competing effects of both the carbon response and the gold response can be seen in the behaviour of the porous material near percolation depicted in FIG. 36.

The sensitivity S (in %) can be quantified as follows:

$$S = \frac{\frac{R - {R}_{0}}{{R}_{0}} \times 100}{Δ \% rh} \times 100$$

where R is the measured resistance, R₀ is the baseline resistance, Δ%rh is the change in humidity during the exposure. For the uncoated and coated porous materials respectively, values of 389 and 170 are found. For this limited range of measured humidity, to the inventors' knowledge, this sensitivity can compete with or exceed existing carbon-based humidity sensors based on a chemiresistor with DC bias.

The following embodiments of the present disclosure are at least partly based on the above discoveries.

In an embodiment, an additional material is deposited onto a porous material comprising carbon (manufactured according to embodiments of the present disclosure or otherwise). The additional material may comprise a metal, such as Au, Pt or Pd, for example. The choice of metal may depend on the nature of a target substance that it is desired to detect with a sensor using the porous material.

In an embodiment, the amount of additional material deposited is controlled (e.g. by controlling a sputtering time, in the case where the additional material is deposited using sputtering) to be in a cross-over regime. The cross-over regime separates a first regime from a second regime.

The first regime corresponds to a range of amounts of the additional material in which a dependence of the electrical resistivity of the porous material on a concentration of a reference substance in an atmosphere around the porous material is dominated by an interaction between the reference substance and carbon in the porous material. In an embodiment, the first regime corresponds to where the coated porous material is below the percolation regime. The electrical response of the porous material in the first regime may thus correspond to the “carbon response” mentioned above. The dependence of the resistivity on the concentration of the reference substance is dominated by an interaction between the reference substance and the carbon of the porous material. In the case where the reference substance comprises (or consists essentially of) water, the dependence of the resistivity is dominated by the interaction between water and carbon. The resistivity of the porous material in the first regime thus increases significantly with decreasing humidity. Point “b” in FIG. 34 is an example sputtering time providing a porous material in the first regime. The corresponding electrical response to humidity is depicted in FIG. 35.

The second regime corresponds to a range of amounts of the additional material in which a dependence of the electrical resistivity of the porous material on a concentration of the reference substance in the atmosphere around the porous material is dominated by an interaction between the reference substance and the additional material deposited on the porous material. In an embodiment, the second regime corresponds to where the coated porous material is above the percolation threshold (and therefore in the percolation regime). The electrical response of the porous material in the second regime may thus correspond to the “metallic response” mentioned above. The dependence of the resistivity on the concentration of the reference substance is dominated by an interaction between the reference substance and the additional material deposited on the porous material. In the case where the reference substance comprises (or consists essentially of) water, the dependence of the resistivity is dominated by the interaction between water and the additional material (e.g. a metal). The resistivity of the porous material in the second regime may thus decrease significantly (e.g. in the case where the additional material is metallic) with decreasing humidity. Point “d” in FIG. 34 is an example sputtering time providing a porous material in the second regime. The corresponding electrical response to humidity is depicted in FIG. 37.

The cross-over regime thus corresponds to a region in between these two extremes of behaviour, close to or at the percolation threshold. In an embodiment, in the cross-over regime the dependence of the electrical resistivity on concentration of the reference substance caused by the interaction between the reference substance and the carbon in the porous material substantially cancels the dependence of the electrical resistivity on concentration of the reference substance caused by the interaction between the reference substance and the additional material deposited on the porous material. Point “c” in FIG. 34 is an example sputtering time providing a porous material in the first regime. The corresponding electrical response to humidity is depicted in FIG. 36.

In an embodiment, the cross-over regime is defined to include a range of amounts of the deposited additional material within 50%, optionally within 25%, optionally within 20%, optionally within 10%, optionally within 5%, optionally within 2.5%, of a cross-over point between where the resistivity of the porous material is observed to increase as a function of concentration of the reference substance and where the resistivity of the porous material is observed to decrease as a function of concentration of the reference substance.

In an embodiment, the cross-over regime is defined to include a range of amounts of the deposited additional material within 50%, optionally within 25%, optionally within 20%, optionally within 10%, optionally within 5%, optionally within 2.5%, of the amount of deposited additional material that would need to be added to an uncoated porous material comprising carbon to reach the percolation threshold. In the case where sputtering is used to deposit the additional material, as in the example of FIG. 34, this may correspond for example to the case where the sputtering time is within 50%, optionally within 25%, optionally within 20%, optionally within 10%, optionally within 5%, optionally within 2.5%, of the time required to reach the cross-over point between where the resistivity is observed to increase as a function of humidity and where the resistivity is observed to decrease as a function of humidity. The amount of additional material corresponding to the percolation threshold is observed to substantially coincide with the cross-over point between where the resistivity is observed to increase as a function of concentration of the reference substance (e.g. humidity) and where the resistivity is observed to decrease as a function of concentration of the reference substance (e.g. humidity), which therefore provides a convenient way of detecting the percolation threshold (or a point close to the percolation threshold that serves the desired purpose of minimizing a sensitivity to the reference substance).

In an embodiment, the cross-over regime is reached when the amount of the deposited additional material is such that percolative behaviour in the additional material is observed but where no significant (or no) decrease in the resistivity is observed with decreasing humidity.

Tuning the porous material to the cross-over regime can thus greatly reduce the sensitivity of the porous material to the presence of a reference substance such as water. This effect can be used to greatly reduce an unwanted background signal.

FIG. 38 depicts an example configuration for exploiting the above effects. In embodiments of this type, the sensor 24 may be configured such that the electrode arrangement can provide a plurality of outputs. Each output is respectively dependent on an electrical property of a portion of a porous material of a different one of a plurality of sensor elements 24A-24C. In the example of FIG. 38, three sensor elements 24A-C are provided but this is not essential. Fewer or more sensor elements could be provided, depending on how many different substances it is desired to detect using the sensor 24. Each sensor element 24A-C comprises a porous material and an electrode arrangement that is able to measure an electrical property (e.g. resistance or resistivity) of a portion of the porous material of that sensor element 24A-C.

A first 24A of the sensor elements 24A-C comprises a porous material in the cross-over regime. The first sensor element 24A may thus be sensitive to a target substance such as NO₂ but relatively insensitive to the reference substance (e.g. humidity).

A second 24B of the sensor elements 24A-C comprises a porous material that is in the first regime or the second regime. The second sensor element 24B may thus be sensitive to a target substance that affects the resistivity of the carbon or the resistivity of the additional material deposited on the carbon and sensitive to the reference substance (e.g. humidity). A combination of the outputs from the first and second sensor elements 24A and 24B may thus be used to obtain a concentration of the reference substance (e.g. humidity) and a concentration of the target substance (NO₂).

In the particular embodiment shown, the second 24B of the sensor elements 24A-C comprises a porous material in the first regime and a third 24C of the sensor elements 24A-C comprises a porous material in the second regime. The combination of outputs from all three sensor elements 24A-C may be used to obtain more accurate information about the concentration of the reference substance (e.g. humidity) and/or obtain information about the concentration of three substances: namely, the reference substance (e.g. humidity), a first target substance that changes the resistivity of carbon significantly, and a second target substance that changes the resistivity of the additional material coating the porous material of the sensor element 24C in the second regime. Further different target substances could be detected by adding further sensor elements having porous materials coated with different additional materials (e.g. different metals).

The above discussion has focused primarily on application to sensors, but the provision of a porous material comprising carbon in the cross-over regime will provide advantages in a range of applications where it is desirable to reduce a sensitivity to humidity or other reference substances, including in supercapacitors for example.

In the discussion above, measurements of an electrical property of the porous material are understood to mean electrical resistance of the whole porous material, including any coating of an additional material provided on the bare carbon backbone.

FIGS. 41-43 depict a variation, applicable to any of the embodiments disclosed herein, in which the collecting substrate 8 is provided next to (laterally adjacent to) the donor material on the support substrate 10 rather than facing the donor material. A deflection substrate 52 is provided that faces both the donor material and the collecting substrate 8. FIGS. 41-42 are top views looking down towards the support substrate 10. The deflection substrate 52 is marked with broken lines. The support substrate 10 and collecting substrate 8 are configured to move (from left to right in the figures) relative to the deflection substrate 52.

FIG. 43 is a schematic side sectional view along a line cutting through the deflection substrate 52, support substrate 10, and collecting substrate 8 (e.g. looking from the right at a planar section of the arrangement of FIG. 41 or 42, the planar section containing a line perpendicular to the page and a line that is oriented vertically within the plane of the page). The donor material is illuminated with laser radiation. The illumination may be performed using any of the laser configurations discussed herein in relation to other embodiments. The illumination comprises scanning a laser spot along a scanning path 54 over the donor material. The scanning path 54 is such that the porous material 14 comprising carbon is formed on the collecting substrate 8 from carbon expelled from the donor material in the wake of the scanning laser spot (i.e. behind the direction of travel of the laser spot over the surface of the donor material). The process is illustrated schematically in FIG. 43. As the laser spot (see broken lines) moves from right to left along scanning path 54, carbon is expelled from the donor material on the support substrate 10 (depicted schematically by the distribution of short thick lines in the region between the deflection substrate 52 and the support substrate 10 and/or collecting substrate 8). The expelled carbon is deflected by the deflection substrate 52 (i.e. prevented from escaping upwards). The momentum of the expelled donor material is such that the expelled donor material travels to the collecting substrate 8 and deposits on the collecting substrate 8 in such a way as to form the porous material 14. The inventors have found that porous material 14 formed this way has particularly advantageous properties, including high sensitivity to target materials of interest when used as part of a sensor 24 (see discussion below referring to FIGS. 44 and 45). The inventors have further found that the porous material is deposited over a wider area in two-dimensions than is typically possible using alternative arrangements in which the collecting substrate 8 faces the donor material. In particular, the porous material spreads over a larger distance in the downwards direction in the orientation of FIGS. 41 and 42 than the porous material spreads in the left and right directions in arrangements of the type depicted in FIG. 24. Increasing the area over which the porous material is formed allows sensors to be manufactured with higher sensitivity and/or with a lower limit of detection. A larger area of an electrode arrangement can be covered efficiently.

In an embodiment, at least 50%, optionally at least 90%, optionally at least 95%, optionally at least 99%, of the porous material comprising carbon that is formed on the collecting substrate 8 is formed while the laser spot is moving further away from the collecting substrate 8.

In the embodiment of FIGS. 41-43, the laser spot is scanned directly away from the collecting substrate 8. The scanning comprises scanning along a scanning path 54 comprising a straight line portion. The spot is moving away from the collecting substrate 8 during all of the time the spot is being scanned along the straight line portion of the scanning path 54. In the embodiment shown, the laser spot is repeatedly scanned along the scanning path 54 while the support substrate 10 and the collecting substrate 8 are moved relative to the deflection substrate 52 (to the right in the Figure shown). FIG. 41 depicts a first instance of scanning along the scanning path 54 for a position of the support substrate 10 and collecting substrate 8 at which the scanning path is approximately aligned with a right hand edge of a sensor 24 on the collecting substrate 8. FIG. 42 depicts a subsequent instance of the scanning along the scanning path 54 after the support substrate 10 and the collecting substrate 8 have moved to the right until the scanning path 54 is approximately aligned with a left hand edge of the sensor 24 on the collecting substrate 8. The laser spot could be scanned along the scanning path 54 many times in between these two positions of the support substrate 10 and the collecting substrate 8. Processed donor material 12 (e.g. reduced graphene oxide in the case where the donor material comprises graphene oxide) is depicted by hatching. The region of processed donor material 12 increases gradually as the support substrate 10 is moved to the right under the scanning laser spot. The process can be repeated as many times as is necessary to build up a desired thickness of the porous material 14 on the collecting substrate 8 (e.g. on interdigitated electrodes formed on the collecting substrate 8 for manufacturing a sensor 24).

The composition of the deflection substrate 52 is not particularly limited, but higher performance has been found where at least a portion of the surface of the deflection substrate 52 facing the donor material resists sticking of carbon to the surface. The inventors have found that hydrophobic surfaces work particularly well. Thus, in some embodiments, at least a portion of the surface of the deflection substrate 52 facing the donor material is arranged to be hydrophobic, such that an equilibrium contact angle of water on the surface in air would be greater than 90 degrees, optionally greater than 100 degrees, optionally greater than 120 degrees, optionally greater than 140 degrees.

In some embodiments, the donor material is illuminated by the laser radiation through the deflection substrate 52 (i.e. into the page in the orientation shown in FIGS. 41-42 and from above in FIG. 43). In such embodiments, the deflection substrate 52 may be substantially transparent to the laser radiation. In some embodiments, the deflection substrate 52 comprises a hydrophobic coating such as Indium Tin Oxide (ITO). In some embodiments, the hydrophobic coating may be ablated away in a thin line by the scanning of the spot along the scanning path 54. This may mean that the hydrophobicity is reduced along the thin line. However, the presence of the hydrophobic coated outside of the thin line means that the deflection substrate 52 will still perform the desired function of efficiently deflecting carbon material towards the collecting substrate 8.

In some embodiments, the deflection substrate 52 is spaced apart from the donor material, for example separated from the donor material by a gap containing gas (e.g. air at ambient temperature and atmospheric pressure). In an embodiment, the gap is less than 5 mm, optionally less than 1 mm, optionally less than 0.5 mm, optionally less than 0.1 mm.

In one particular example of an embodiment of the type depicted in FIGS. 41-43, the deflection substrate 52 comprises ITO (e.g. as a coating on glass) and is moved over a donor material comprising graphene oxide with an air-gap of 1 mm. The donor material in this embodiment is moved in 7 micron steps.

FIGS. 44 and 45 depict the result of measurements using a sensor 24 manufactured by depositing the porous material 14 using the method discussed above with reference to FIGS. 41-43. FIG. 44 depicts a sensor response to 250 ppb NO₂, the sensor 24 being exposed to the NO₂ during the period between the vertical broken lines. FIG. 45 depicts a sensor response to 25 ppb NO₂, the sensor 24 being exposed to the NO₂ during the period between the vertical broken lines. Both concentrations of NO₂ can be detected clearly and unambiguously. In this particular embodiment, concentrations down to around 38 μg/m³ of NO₂ could be detected.

FIGS. 46-48 depict a variation on the embodiments described above with reference to FIGS. 41-45. FIG. 46 is a top view corresponding to the top views of FIGS. 41-42 but the laser spot is scanned along a scanning path 54′ that includes one or more portions over the collecting substrate 8 and one or more portions over the donor material on the support substrate 10. Thus, the laser spot is not scanned purely over the support substrate 10 as in FIGS. 41-43. The scanning of the laser spot may be as described above with reference to FIGS. 41-43 except that instead of starting each scan from a position that is over the support substrate 10 each scan is started from a position that is over the collecting substrate 8. Thus, the scanning path 54′ may comprise a plurality of straight line portions in which a first portion of each straight line portion is over the collecting substrate 8 and a second portion of each straight line portion is over the support substrate 10. As described above, while the laser spot is being scanned over the support substrate 10 porous material 14 comprising carbon is formed on the collecting substrate 8 from carbon expelled from the donor material in the wake of the scanning laser spot. In an embodiment, this process involves conversion of graphene oxide to reduced graphene oxide on the support substrate 10 and the formation of the porous material 14 comprising carbon comprises diffusion of carbon clusters out of a carbon plasma formed by the laser interacting with the donor material. The laser spot is repeatedly scanned along the scanning path 54′ while the support substrate 10 and the collecting substrate 8 are moved relative to the deflection substrate 52 (to the right in the Figure shown). When the laser spot is scanned over portions of the collecting substrate 8 on which the porous material 14 comprising carbon has been formed by scanning of the laser spot at an earlier time (e.g. along an adjacent or nearby one of the straight line portions), the laser spot anneals the porous material 14. Annealing the porous material in this way has been found to greatly improve adhesion between the porous material 14 and the collecting substrate 8. By scanning the laser spot over both of the collecting substrate 8 and the support substrate 10, it is possible to form the porous material 14 and anneal the porous material 14 efficiently in a single process. In an example embodiment of this process, the laser spot is produced by an infrared laser with a set fluence of 417 mJ/cm² focused onto a deflection substrate 52 comprising a layer of ITO and a galvoscanner is used to scan the laser spot.

FIG. 47 schematically shows the result of repeated scanning of the laser spot as described above to form a body of the porous material 14 that comprises a first layer 61 directly adjacent to the electrode arrangement 32 and a second layer 62 above (and optionally partially around) the first layer 61. The first layer 61 is between the collecting substrate 8 and the second layer 62. It has been found that removing the second layer 62 improves performance of the sensor. In an embodiment, the second layer 62 is removed by providing a flow of fluid (such as gas from a pressurized air source) over the arrangement. In the example shown a pressurized gas source 64 is used to blow air over the porous material 14 to remove the second layer 62. FIG. 48 depicts the arrangement after the second layer 62 has been removed to leave only the first layer 61. The first layer 61 of the porous material 14 has been found to function highly efficiently in a sensor (as discussed below). The second layer 62, while present, has a lower density (more volumetric) structure and has been found to inhibit diffusion of analyte material to the first layer 61. Removing the second layer 62 improves the performance of the sensor relative to when the second layer 62 is not removed. The first layer 61 may be referred to as an active layer and the second layer 62 may be referred to as a diffusion barrier layer.

FIGS. 49(a)-(d) depict SEM images of different stages of manufacture of a sensor using the method discussed above with reference to FIGS. 46-48. FIG. 49(a) is a view of an electrode arrangement 32 produced using laser ablation acting on a stack of a glass substrate with molybdenum on top. FIG. 49(b) is a view of the second (volumetric) layer 62 of the porous material 14 on top of the electrode arrangement 32 prior to removal. FIG. 49(c) is a view of the first (active) layer 61 of the porous material 14 after annealing by the laser spot. The first layer 61 is seen to have a highly uniform porosity. FIG. 49(d) is a higher magnification view of the first layer 61 of the porous material 14 of FIG. 49(c) showing diffusion limited aggregated carbon clusters in a porous network, with cluster sizes around 20 nm. SEM image analysis reveals a fractal dimension of 1.8 in the first layer 61 of the porous material 14 and a thickness of below 100 nm. The estimated surface area density is above 200 m²/g.

Sensors were formed using the method of FIGS. 46-48 (including removal of the second layer 62) and exposed to various concentrations between 10 ppb and 1 ppm of NO₂ in a dry air environment while the resistance was monitored. Example results are shown in FIG. 50. The porous material 14 does not recover its baseline on its own. A heating step (at 100 degrees C.) is introduced to recover the baseline after the exposure. FIG. 51 shows the response of the sensor to various concentrations. A Langmuir fitting of the form S₀=SₘₐₓKP/(1+KP) fits the trend well. The good fit shows the absorption is happening on the surface of the material, which is the case in nanostructured materials. FIG. 52 shows sensitivity of the sensor to NO₂ concentrations down to 10 ppb. The graph shows a variation of measured resistance against time and a clear step response between the different concentrations is visible with adsorption times (t₉₀) of around 10 min.

FIG. 53 depicts variation of measured resistance against time for the annealed porous material 14 exposed to various different gases. A clear response to 1 ppm NO₂ is visible in the initial exposure. A heating step is applied to recover the baseline between the different exposures. Upon exposure to 1 ppm ammonia (NH₃) a response is visible. When the porous material 14 is exposed to nitrogen (N₂) alone a response is also visible. The response of the N₂ comes from the fact that it is dryer than the dry air applied during the measurement. This shows a clear sensitivity towards changes in humidity. Because the NH₃ is diluted with N₂ the drop in resistance is accounted for the change in humidity rather than an interaction of the NH₃ with the porous material 14. No interaction of the porous material 14 with carbon dioxide (CO₂), isopropanol (IPA) or acetone is visible. Upon exposure to 1 ppm NO₂ the CNF is reacting with almost double the response of the first exposure.

The performance of the annealed porous material 14 in gas sensor applications meets regulation specifications in the EU. It shows a measurable change in a concentration below the annual limit of 20 ppb. The response time is below 15 min. The selectivity is exceptional compared to other pure carbon based sensor devices. Without any functionalisation it does not react to common air pollutants except to NO₂. The strong reaction towards humidity is common at room temperature. A thin film of water is formed in any humid environment on the carbon. A Grotthuus-chain reaction is taking place in the water layer where hydrogen atoms are shared between the water molecules contributing to the conductivity of the nanostructure lying beneath. For investigating the sensing mechanism towards NO₂ and the selectivity, an XPS analysis was done to find the elemental composition of the annealed porous material 14 in order to understand the chemical interaction of the NO₂ with the oxygen functional groups. The oxygen functional groups are responsible for the chemisorption on the porous material 14 which is, beside physisorption on the porous material 14, the main sensing mechanism. The XPS spectrum of the active layer is depicted in FIGS. 54 and 55. Fitting of the C1 s spectra (FIG. 54) yields five components located at binding energies (BE) of 284.5 eV (sp² C=C species), 285.6 eV (carbon atoms in sp³ structures), 286.8 eV (C—O, alcohol/ether/epoxy groups), 288.5 eV (C═O, carbonyl groups), 290.4 eV (COOH, carboxyacid/ester groups). Deconvolution of O1 s spectra (FIG. 55) yields 3 major peaks around 530.9, 531.9 and 533.0 eV assigned to C═O (carbonyl groups, highly conjugated forms like quinone), C—O (carbon-oxygen single bonds in hydroxyls) and C—O—C (carbon-oxygen single bond in epoxy groups). The spectra also shows an additional small peak at higher BE (536.2 eV) assigned to chemisorbed/intercalated water molecules.

NO₂ is a strong oxidising agent, which acts as electron acceptor and presents electrophilic properties. All these properties allow NO₂ to being adsorbed on the surface of the sensor relatively tight via hydrogen bonding. The hydrogen bonding most likely takes place with the hydrogen of the —COOH functional groups. The adsorbed NO₂ depletes the porous material 14 of electrons. Carbon at room temperature in humid environments are typically p-type materials. Depletion of electrons releases more hole majority carriers therefore decreasing the resistance as seen in FIG. 50.

The selectivity arises from the fact that other gases are less strong oxidizing agents. There is barely interaction with the oxygen functional groups at low concentrations. Higher concentrations of the interferants can give show a change in resistance. These responses are significantly lower compared to the NO₂ signal, showing that interferants are not poisoning the porous material 14 permanently.

Thus, a annealed porous material 14 comprising carbon is formed in a one-step laser process and used to detect gases. Exposure to NO₂ shows sensitivity of detection below 10 ppb. The porous material 14 shows great selectivity towards other polluting gases making it unique amongst the carbon nanomaterials. NO₂ adsorbs via hydrogen bonding with the carboxyacids on the surface of the porous material 14.

The following numbered clauses disclose further embodiments of the disclosure.
1. A method of manufacturing a sensor, comprising:
   providing a donor material on a support substrate, the donor material comprising carbon or a carbon compound;
   providing a collecting substrate facing the donor material; and
   illuminating the donor material with laser radiation, wherein the illumination is such that a porous material comprising carbon is formed on the collecting substrate, wherein:
   the collecting substrate comprises an electrode arrangement configured to provide an output dependent on an electrical property of a portion of the porous material.
2. The method of clause 1, wherein the porous material is formed on the collecting substrate at atmospheric pressure.
3. The method of clause 1 or 2, wherein the layer of donor material is illuminated by the laser radiation through the collecting substrate.
4. The method of any preceding clause, wherein a gap between the collecting substrate and the donor material on the support substrate is less than 5 mm during the formation of the porous material on the collecting substrate.
5. The method of any preceding clause, wherein the illumination of the donor material with the laser radiation is performed with a focal point of the laser radiation positioned nearer to the surface of the collecting substrate facing the donor material than to the donor material on the support substrate.
6. The method of any preceding clause, wherein the support substrate is moved relative to the collecting substrate during the illumination of the donor material or in between illumination of one region of the donor material and illumination of a subsequent region of the donor material.
7. The method of clause 6, wherein simultaneously or at different times the support substrate is moved linearly in a first direction and the laser radiation is scanned linearly in a second direction, perpendicular to the first direction.
8. The method of any preceding clause, wherein the donor material comprises one or more of graphene oxide, graphene, and graphite.
9. The method of any preceding clause, wherein the layer of donor material comprises graphene oxide and the fluence of the laser radiation is in the range 140-220 mJ/cm².
10. The method of any preceding clause, wherein the porous material comprises a three-dimensional network with elongate connecting structures formed from carbon.
11. The method of clause 10, wherein at least one of the elongate connecting structures has an unbranched length of 50 microns or more.
12. The method of any preceding clause, wherein the porous material comprises a Raman G-peak at 1556±2 cm⁻¹.
13. The method of any preceding clause, wherein the porous material comprises 5-15% sp³ bonds.
14. The method of any preceding clause, wherein the electrode arrangement is configured to provide an output dependent on a resistivity of a portion of the porous material.
15. The method of any preceding clause, comprising:
   laser ablating a layer of metal formed on the collecting substrate to form at least part of the electrode arrangement, wherein:
   the illumination of the donor material is performed through the collecting substrate after the formation of the at least part of the electrode arrangement.
16. The method of clause 15, further comprising:
   splitting the at least part of the electrode arrangement into two disconnected electrode arrangements by removing metal from a band separating the two disconnected electrode arrangements, wherein:
   the illumination of the donor material is performed through the band separating the two disconnected electrode arrangements.
17. The method of any preceding clause, wherein:
   the electrode arrangement comprises a plurality of interlocked finger electrodes; and
   the porous material provides an electrical path between at least two of the finger electrodes.
18. The method of any preceding clause, further comprising depositing an additional material onto the porous material.
19. The method of any preceding clause, wherein the sensor is configured to provide an output dependent on an interaction between a target substance and the porous material.
20. The method of clause 19, wherein the target substance comprises ammonia.
21. A sensor manufactured using the method of any preceding clause.
22. A sensor for measuring a target substance, comprising:
   an electrode arrangement configured to provide an output dependent on an electrical property of a portion of a porous material, wherein:
   the porous material comprises a three-dimensional network with elongate connecting structures formed from carbon, wherein the elongate connecting structures are not tubular.
23. A method of manufacturing a filter, comprising:
   providing a donor material on a support substrate, the donor material comprising carbon or a carbon compound;
   providing a collecting substrate facing the donor material; and
   illuminating the donor material with laser radiation, wherein the illumination is such that a porous material comprising carbon is formed on the collecting substrate.
24. The method of clause 23, wherein the collecting substrate is porous.
25. The method of clause 23 or 24, further comprising selectively removing a portion of the collecting substrate to form a freestanding membrane comprising the porous material.
26. The method of any of clauses 23-25, further comprising depositing an additional material on the porous material.
27. The method of any of clauses 23-26, wherein the additional material forms a continuous metallic network.
28. A filter manufactured using the method of any of clauses 23-27.
29. A filter comprising a porous material, the porous material comprising a three-dimensional network with elongate connecting structures formed from carbon, wherein the elongate connecting structures are not tubular.
30. The filter of clause 29, wherein the porous material is provided on a porous substrate formed from a different material.
31. The filter of clause 29 or 30, wherein the porous material is provided as a freestanding membrane.
32. A method of manufacturing a porous material comprising a continuous metallic network, comprising:
   providing a donor material on a support substrate, the donor material comprising carbon or a carbon compound;
   providing a collecting substrate facing the donor material;
   illuminating the donor material with laser radiation, wherein the illumination is such that a porous material comprising carbon is formed on the collecting substrate; and
   depositing a metal onto the porous material until a continuous metallic network is formed on the porous material, thereby providing a porous material comprising a continuous metallic network.

### Further Experimental Details

Graphite oxide was prepared from graphite powder (Sigma Aldrich, Ref 332461) using a modified Hummers' method as described elsewhere. In brief, 170 mL of concentrated H₂SO₄ was added to a mixture of graphite flakes (5.0 g) and NaNO₃ (3.75 g). The mixture was vigorously stirred for 30 minutes in an ice bath. KMnO₄ (25 mg) was slowly added while stirring for another 30 minutes. The reaction was then warmed up to 35° C. and stirred overnight. Subsequently, distilled water (250 ml) and 30% H₂O₂ (20 mL) were slowly added in sequence. The mixture was stirred for 1 hour, filtered and washed repeatedly with 400 mL of HCl:H₂O (1:10), and dried in air, thus yielding graphite oxide. Finally, the resulting graphite oxide was dispersed in water at a concentration of 2 mg/mL and bath sonicated for 2 hours. This led to a brown-colored dispersion of exfoliated graphene oxide flakes.

The GO dispersion was spray deposited on to untreated soda-lime glass substrates using a hand-held air brush (Badger Model XL2000). The glass substrate was placed on a hotplate to enhance the evaporation rate of the water. Multiple spray passes were used to deposit a film with a thickness approximately 200 nm. The sample was then placed in an oven and the temperature was ramped to 250° C. over 1.5 hours and then taken out cool at room temperature.

An MSV-101 (M-Solv Ltd, Oxford) laser materials processing machine, equipped with a 1064 nm wavelength, nanosecond-pulsed laser (Multiwave MOPA-DY Series Pulsed Fiber Laser, set to 10 ns pulse duration and 200 kHz pulse repetition frequency) and galvoscanner was used for the graphene oxide reduction and consequent deposition of the porous material comprising carbon. For the fluence window determination a frequency of 100 kHz and a mark speed of 30 mm/sec was used. For the deposition a glass microscope slide was placed 1 mm above the graphene oxide target. The laser beam was set up to pass through the (transparent) slide and its 25 gm focal spot was scanned over the graphene oxide partly reducing it to reduced graphene oxide and partly ablating it which results in the deposition of the porous material comprising carbon onto the glass. The slide was kept stationary while the graphene oxide target was moved in by 7 gm, orthogonal to the laser scan direction, after each pass of the beam, to expose fresh graphene oxide target material. The laser fluence was set to 400 mJ/cm² with a scan speed of 100 mm/s.

Samples were imaged with a Zeiss SIGMA field emission gun scanning electron microscope (FEG-SEM) using a Zeiss in-lens secondary electron detector. The FEG-SEM working conditions used were; 2.5 kV accelerating voltage, 20 μm aperture, and 2 mm working distance.

A Bruker Dimension Icon atomic force microscope (AFM) was used in peak force mode to measure topography.

The Raman measurements were carried out with a Renishaw inVia confocal Raman microscope with a 532 nm solid-state laser and a ×50 objective lens (NA=0.75). Graphene oxide and reduced graphene oxide were probed with 0.6 mW and the CNF with 0.06 mW laser intensity.

Gold was sputtered using a BIO-RAD SC 510 ‘cool’ sputter coater. The current was held constant at 20 mA, the chamber vacuum was held at a constant pressure of 0.1 mbar. The thickness was controlled by varying the sputtering time.

Humidity measurements were performed using pressurized nitrogen and a Alicat mass flow controller to maintain a flowrate of 500 sccm. The porous material comprising carbon was placed in a small measurement chamber (200 ml volume) contacted to measure its resistance using a Keithley 2420 source meter by applying a constant current and monitoring the voltage across the device. The baseline was measured at ambient with an open lid, the lid was closed and the chamber purged with nitrogen while the resistance was monitored. When the signal reached steady state the flow of nitrogen was interrupted and the lid opened to expose the device to ambient again. The humidity changed from 38%rh at ambient to 20%rh in the nitrogen environment.

The porous material comprising carbon was deposited onto a substrate mounted holey carbon grid. The porous material was imaged using a transmission electron microscope (TEM) FEI Titan operating at 300 keV. Both bright field TEM and annular dark field scanning TEM modes were used.

HRTEM images were taken at a FEI Titan High-Base microscope equipped with a CEOS CETCOR Cs objective lens corrector, working at 80 keV and a low temperature. Images were acquired using a Gatan 626 single-tilt liquid nitrogen cryo-holder, allowing for the sample to be kept at ˜77 K while performing this study.

1. A method of manufacturing a sensor, comprising:
providing a donor material on a support substrate, the donor material comprising carbon or a carbon compound;
providing a collecting substrate; and
illuminating the donor material with laser radiation, wherein the illumination is such that a porous material comprising carbon is formed on the collecting substrate, wherein:
the collecting substrate comprises an electrode arrangement configured to provide an output dependent on an electrical property of a portion of the porous material;
a deflection substrate is provided facing the donor material and the collecting substrate; and
the illumination of the donor material with laser radiation comprises scanning a laser spot along a scanning path over the donor material, the scanning path being such that the porous material comprising carbon is formed on the collecting substrate from carbon expelled from the donor material in the wake of the scanning laser spot.

2. The method of claim 1, wherein the porous material is formed on the collecting substrate at atmospheric pressure.

3. The method of claim 1, further comprising depositing an additional material onto the porous material.

4. The method of claim 3, wherein the amount of additional material deposited is controlled to be in a cross-over regime defined so as to include a range of amounts of the deposited additional material within 25% of a cross-over point between where the resistivity of the porous material is observed to increase as a function of concentration of a reference substance in an atmosphere around the porous material and where the resistivity of the porous material is observed to decrease as a function of concentration of the reference substance in the atmosphere around the porous material.

5. The method of claim 3, wherein the amount of additional material deposited is controlled to be in a cross-over regime separating a first regime and a second regime, wherein:
the first regime corresponds to a range of amounts of the additional material in which a dependence of the electrical resistivity of the porous material on a concentration of a reference substance in an atmosphere around the porous material is dominated by an interaction between the reference substance and carbon in the porous material; and
the second regime corresponds to a range of amounts of the additional material in which a dependence of the electrical resistivity of the porous material on a concentration of the reference substance in the atmosphere around the porous material is dominated by an interaction between the reference substance and the additional material deposited on the porous material.

6. The method of claim 5, wherein, in the cross-over regime, the dependence of the electrical resistivity on concentration of the reference substance caused by the interaction between the reference substance and the carbon in the porous material substantially cancels the dependence of the electrical resistivity on concentration of the reference substance caused by the interaction between the reference substance and the additional material deposited on the porous material.

7. The method of claim 3, wherein the amount of additional material deposited is controlled to be in a cross-over regime defined so as to include a range of amounts of the deposited additional material within 25% of the amount of deposited additional material that would need to be added to the uncoated porous material comprising carbon to reach the percolation threshold of the additional material.

8. The method of claim 3, wherein the reference substance comprises water.

9. The method of claim 3, wherein the additional material comprises a metal.

10.-30. (canceled)

31. A method of manufacturing a filter, comprising:
providing a donor material on a support substrate, the donor material comprising carbon or a carbon compound;
providing a collecting substrate; and
illuminating the donor material with laser radiation, wherein the illumination is such that a porous material comprising carbon is formed on the collecting substrate, wherein:
a deflection substrate is provided facing the donor material and the collecting substrate; and
the illumination of the donor material with laser radiation comprises scanning a laser spot along a scanning path over the donor material, the scanning path being such that the porous material comprising carbon is formed on the collecting substrate from carbon expelled from the donor material in the wake of the scanning laser spot.

32. The method of claim 31, wherein the collecting substrate is porous.

33. The method of claim 31, further comprising selectively removing a portion of the collecting substrate to form a freestanding membrane comprising the porous material.

34. The method of claim 31, further comprising depositing an additional material on the porous material, wherein the additional material forms a continuous metallic network.

35.-42. (canceled)

43. A method of manufacturing a porous material comprising a continuous metallic network, comprising:
providing a donor material on a support substrate, the donor material comprising carbon or a carbon compound;
providing a collecting substrate;
illuminating the donor material with laser radiation, wherein the illumination is such that a porous material comprising carbon is formed on the collecting substrate; and
depositing a metal onto the porous material until a continuous metallic network is formed on the porous material, thereby providing a porous material comprising a continuous metallic network, wherein:
a deflection substrate is provided facing the donor material and the collecting substrate; and
the illumination of the donor material with laser radiation comprises scanning a laser spot along a scanning path over the donor material, the scanning path being such that the porous material comprising carbon is formed on the collecting substrate from carbon expelled from the donor material in the wake of the scanning laser spot.

44.-55. (canceled)

56. A method of manufacturing a porous material comprising carbon, comprising:
providing a donor material on a support substrate, the donor material comprising carbon or a carbon compound;
providing a deflection substrate facing the donor material and a collecting substrate; and
scanning a laser spot along a scanning path over the donor material, the scanning path being such that a porous material comprising carbon is formed on the collecting substrate from carbon expelled from the donor material in the wake of the scanning laser spot.

57. The method of claim 56, wherein at least 90% of the porous material comprising carbon that is formed on the collecting substrate is formed while the laser spot is moving further away from the collecting substrate.

58. The method of claim 56, wherein at least a portion of a surface of the deflection substrate facing the donor material is hydrophobic.

59. The method of claim 56, wherein the laser spot is scanned along a scanning path that includes one or more portions over the collecting substrate and one or more portions over the donor material.

60. The method of claim 59, wherein the scanning of the laser spot over the one or more portions over the collecting substrate act to anneal porous material comprising carbon formed by the scanning of the laser spot at an earlier time.

61. The method of any of claim 56, wherein:
the porous material comprising carbon formed on the collecting substrate comprises a first layer and a second layer, the first layer being between the collecting substrate and the second layer; and
the method further comprises removing the second layer.
